(19) United States
(12) Patent Application Publication
(10) Pub. No.: US 2009/0048925 A1
(43) Pub. Date: Feb. 19, 2009

(54) METHOD OF RANKING KEYWORD ADVERTISEMENTS USING CLICK THROUGH RATE

(75) Inventors: KI HO SONG, SEOUL (KR); JONG HO PARK, SEOUL (KR)

Correspondence Address: KNOBBE MARTENS OLSON & BEAR LLP, 2040 MAIN STREET, FOURTEENTH FLOOR, IRVINE, CA, 92614, US

(73) Assignee: NHN CORPORATION, SEONGNAM-SI (KR)

(21) Appl. No.: 12/190,836

(22) Filed: Aug. 13, 2008

(30) Foreign Application Priority Data
Aug. 14, 2007 (KR) 10-2007-0081887

(51) Int. Cl. G06Q 30/00

(52) U.S. Cl. 705/14

(57) ABSTRACT

Disclosed is a method of running a keyword advertisement service, which comprises providing a CTR-at-rank of a first keyword advertisement using a keyword, providing an average CTR-at-rank of a plurality of keyword advertisements, and computing an adjusted CTR of the first keyword advertisement using the CTR-at-rank and the average CTR-at-rank. The CTR-at-rank of the first keyword advertisement represents a click-through rate for the first keyword advertisement during a predetermined period. The average CTR-at-rank represents an average value of collective click-through rates of the plurality of keyword advertisements during a preselected period.

### CROSS-REFERENCE TO RELATED APPLICATION

This application claims the benefit of Korean Patent Application No. 10-2007-0081887, filed on Aug. 14, 2007, in the Korean Intellectual Property Office, the disclosure of which is incorporated herein by reference.

### BACKGROUND

1. Field

The present disclosure relates to a keyword advertising service, and more particularly, to ranking keyword advertisements using click-through rates (CTRs).

2. Discussion of Related Technology

A keyword advertisement denotes a type of advertisement that can display advertisements in a search result page when advertisers purchase a particular keyword and then a user searches for a desired advertisement using a search word including the keyword. For example, when the user enters a keyword associated with “relocation” for searching, advertisements associated with “packing relocation”, “relocation help center”, and the like are retrieved. In this instance, in an aspect that an advertisement is displayed for only a person interested in a particular product or item, the keyword advertisement is different from an existing banner advertisement. Specifically, since the advertisement is exhibited for only the person that has interest in the particular product or the item, it is possible to improve the target advertising effect and click rate.

The keyword advertisement includes cost-per-click (CPC) advertisement and a cost-per-mill (CPM) advertisement. In the CPC advertisement, regardless of a number of displays after searching, only when a user clicks on a corresponding advertisement is an advertiser charged. Specifically, the advertiser deposits a predetermined amount of money in advance. Only when an advertisement is displayed at search results of an associated keyword and a user is connected to a linked site through clicking on the advertisement is a cost per click deducted from the deposited money. In the CPM advertisement, a flat sum is set with respect to an ongoing advertisement of a predetermined period of time and the advertiser is charged up to the flat sum regardless of any clicks on the advertisement.

In a keyword advertisement, a rank of advertisement is determined simply based on a bid amount set for each of various advertisement regions and a corresponding advertisement is displayed according to its rank. Specifically, regardless of the quality of the advertisement, the advertising effect, and the like, a user has no choice but to view advertisements based on bid amounts of advertisers. Also, on the side of advertisers, they may need to bid for a keyword for each of numerous advertisement regions in order to enable their advertisements to be displayed in the advertisement regions.

The foregoing discussion is to provide general background information, and does not constitute an admission of prior art.

### SUMMARY

One embodiment of the invention provides a method of running a keyword advertisement service. The method comprises providing a plurality of CTRs-at-rank of a first keyword advertisement using a keyword, wherein each CTR-at-rank of the first keyword advertisement represents a click-through rate for the first keyword advertisement during a predetermined period when the first keyword advertisement is at each of the plurality of ranks among a group of keyword advertisements using the same keyword; providing a plurality of average CTRs-at-rank of a plurality of keyword advertisements, wherein each average CTR-at-rank represents an average value of collective click-through rates of the plurality of keyword advertisements during a preselected period when each of the plurality of keyword advertisements is at one of the plurality of ranks; and computing an adjusted CTR of the first keyword advertisement using, at least in part, the plurality of CTRs-at-rank of the first keyword advertisement and the plurality of average CTRs-at-rank of the plurality of keyword advertisements.

In the foregoing method, computing may further use a count of listings of the first keyword advertisement contained in keyword search results formulated in reply to keyword searches using the keyword during the predetermined period. Two or more of the group of keyword advertisements may be at the same rank at different times during the predetermined period. The predetermined period may be same with the preselected period. Providing the plurality of CTRs-at-rank ma y comprise providing a count of listings of the first keyword advertisement contained in keyword search results formulated in reply to keyword searches using the keyword when the first keyword advertisement is at a first one of the plurality of ranks during the predetermined period; providing a count of clicks of the first keyword advertisement when the first keyword advertisement is at the first rank during the predetermined period; and computing a first CTR-at-rank for the first rank using the count of listings and the count of clicks.

Still in the foregoing method, a first CTR-at rank of the first keyword advertisement may be a ratio of a count of click-throughs to a count of listings of the first keyword advertisement as the first rank on keyword search results during the predetermined period, wherein the first CTR-at-rank is not used in computing the adjusted CTR of the first keyword advertisement when the count of listings as the first rank is smaller than or equal to a predetermined number. A first CTR-at rank of the first keyword advertisement may be a ratio of a count of click-throughs to a count of listings of the first keyword advertisement as the first rank on results of keyword searches, wherein the first CTR-at-rank is not used in computing the adjusted CTR of the first keyword advertisement when the number of the keyword searches during the predetermined period is smaller than or equal to a predetermined number. The collective click-through rates at a particular rank may be a sum of a CTR-at-rank of each keyword advertisement of the all or part of the plurality of keyword advertisements when said each keyword advertisement is at the particular rank.

Yet in the foregoing method, computing may comprise subtracting a first one of the plurality of average CTRs-at-rank for a first one of the plurality of ranks from a first one of the plurality of CTRs-at-rank for the first rank so as to generate a first adjusted CTR-at-rank of the first keyword advertisement for the first rank. Computing may further comprise repeating subtracting an average CTR-at-rank of the plurality of keyword advertisements from a CTR-at-rank of the first keyword advertisement for the remainder of the plurality of ranks so as to generate an adjusted CTR-at-rank of the first keyword advertisement for each of the remainder of the plurality of ranks. Computing may further comprise summing the first adjusted CTR-at-rank and the adjusted CTRs-at-rank so as to generate said adjusted CTR of the keyword advertisement.

The foregoing method may further comprise ranking the first keyword advertisement among the group of keyword advertisements using the adjusted click-through rate (CTR) of the first keyword advertisement. Ranking may comprise comparing the adjusted CTR of the first keyword advertisement against CTRs or adjusted CTRs of the others of the group of keyword advertisements. The foregoing method may further comprise: receiving, from a user's terminal, a request for a keyword search using the keyword; conducting a keyword search using the keyword; and transmitting, to the user's terminal, a result of the keyword search along with all or part of the group of keyword advertisements such that the keyword advertisements are displayed in an order according to rankings thereof.

Another aspect of the invention provides a method of running a keyword advertisement service. The method comprises providing a plurality of CTRs-at-rank of a first keyword advertisement using a keyword, wherein each CTR-at-rank of the first keyword advertisement represents a click-through rate for the first keyword advertisement during a predetermined period when the first keyword advertisement is at each of the plurality of ranks among a group of keyword advertisements using the same keyword; providing a plurality of adjustment factors for adjusting the CTRs-at-rank, each adjustment factor is associated with one of the plurality of ranks; and computing an adjusted CTR of the first keyword advertisement, at least in part, using the plurality of CTRs-at-rank and the plurality of adjustment factors.

In the foregoing method, computing the adjusted CTR of the first keyword advertisement may comprise computing a plurality of adjusted CTRs-at-rank of the first keyword advertisement. A first one of the plurality of adjusted CTRs-at-rank for a first one of the plurality of ranks may be computed with a formula using a first one of the plurality of CTRs-at-rank representing a CTR when the first keyword advertisement is at the first rank and a first adjustment factor. At least one of the formula and the adjustment factor may be designed such that the first adjusted CTR-at-rank becomes smaller than the first CTR-at-rank when the first rank is the highest rank among the plurality of ranks. The formula may comprise a multiplication of the first adjustment factor by the first CTR-at-rank. The formula may comprise a subtraction of the first adjustment factor from the first CTR-at-rank. The first adjustment factor may be an average CTR-at-rank of a plurality of keyword advertisements and represents an average value of collective click-through rates of the plurality of keyword advertisements during a preselected period when each of the group of keyword advertisements is at the first rank. The collective click-through rates at the first rank may be the sum of CTRs-at-rank of each of the plurality of keyword advertisements when said each keyword advertisement is at the particular rank.

Still in the foregoing method, computing the adjusted CTR of the first keyword advertisement may further comprise summing the plurality of adjusted CTRs-at-rank of the first keyword advertisement. Computing the adjusted CTR of the first keyword advertisement may further comprise summing only part of the plurality of adjusted CTRs-at-rank of the first keyword advertisement. The foregoing method may further comprise ranking the first keyword advertisement among the group of keyword advertisements using the adjusted CTR of the first keyword advertisement. Ranking may comprise comparing the adjusted CTR of the first keyword advertisement against CTRs or adjusted CTRs of the others of the group of keyword advertisements. The plurality of keyword advertisements may use the keyword. The plurality of keyword advertisements may comprise entire keyword advertisements used in a keyword advertisement service or a portion of the entire keyword advertisements.

Still another aspect of the invention provides a method of running a keyword advertisement service. The method comprises providing a CTR-at-rank of a first keyword advertisement using a keyword, wherein the CTR-at-rank of the first keyword advertisement represents a click-through rate for the first keyword advertisement during a predetermined period when the first keyword advertisement is at a first one of the plurality of ranks among a group of keyword advertisements using the same keyword; providing an average CTR-at-rank of a plurality of keyword advertisements, wherein the average CTR-at-rank represents an average value of collective click-through rates of the plurality of keyword advertisements during a preselected period when the plurality of keyword advertisements is at the first rank; and computing an adjusted CTR of the first keyword advertisement using the CTR-at-rank of the first keyword advertisement and the average CTR-at-rank of the plurality of keyword advertisements.

One aspect of the present invention provides a method of revising a click-through rate (CTR), the method comprising: measuring a CTR for each rank of an advertisement for a predetermined period of time; calculating the per-rank average CTR for each rank; and calculating a rank-revised CTR based on the CTR, the per-rank average CTR, and a number of displays of the advertisement.

In the foregoing method, the measuring of the CTR may comprise: accumulating a number of displays and a number of clicks, changing over time, for each rank; and calculating the CTR based on the number of displays and the number of clicks.

In the still foregoing method, the calculating of the rank-revised CTR may comprise: calculating, for each rank, the difference between the per-rank average CTR and the CTR existing in the same rank; assigning, to the difference for each rank, a weight according to the number of displays; and calculating the average difference with the assigned weight, as the rank-revised CTR. The maximum cost per click may be input by an advertiser of the advertisement as a maximum cost of the advertisement per click.

In the still foregoing method, the CTR may include a number of displays greater than or equal to a number of reliable displays. The number of reliable displays may be calculated based on a number of average daily references of a corresponding keyword and a number of average daily displays of the keyword.

In the still foregoing method, the per-rank average CTR may include the average CTR of all the keywords existing in the same rank, for each rank.

In the still foregoing method, the rank may determined based on a ranking index, the ranking index being based on a quality index and a maximum cost per click of the advertisement.

Another aspect of the present invention provides a system for revising a CTR, the system comprising: a CTR measuring module configured to measure a CTR for each rank of an advertisement for a predetermined period of time; a per-rank average CTR calculating module configured to calculate the average per-rank CTR for each rank; and a rank-revised CTR calculating module configured to calculate a rank-revised CTR based on the CTR, the per-rank average CTR, and a number of displays of the advertisement.

One aspect of the present invention provides a method and system for revising a CTR that can calculate a ranking index based on a quality factor indicating the quality of an advertisement and CTR indicating the advertising effect and display the advertisement based on the ranking index, and thereby can reflect the advertisement quality and the advertising effect in a display rank of the advertisement.

Another aspect of the present invention also provides a method and system for revising a CTR that can revise a CTR based on a per-rank average CTR corresponding to the average CTR of all the keywords existing in each rank and a weight according to a number of displays and thereby can remove a premium according to a display rank of an advertisement.

### BRIEF DESCRIPTION OF THE DRAWINGS

The above and other aspects and advantages of the present invention will become apparent and more readily appreciated from the following detailed description, taken in conjunction with the accompanying drawings of which:

FIG. 1 is a flowchart illustrating a method of providing an advertisement according to an embodiment of the present invention;

FIG. 2 illustrates an example of calculating a ranking index according to an embodiment of the present invention;

FIG. 3 is a flowchart illustrating a method of revising a click-through rate (CTR) according to an embodiment of the present invention;

FIG. 4 is a flowchart illustrating a method of calculating a rank-revised CTR according to an embodiment of the present invention;

FIG. 5 illustrates an example of revising a CTR according to an embodiment of the present invention; and

FIG. 6 is a block diagram illustrating an internal configuration of a system for revising a CTR according to an embodiment of the present invention.

### DETAILED DESCRIPTION OF EMBODIMENTS

Reference will now be made in detail to various embodiments of the present invention, examples of which are illustrated in the accompanying drawings, wherein like reference numerals refer to the like elements throughout. Embodiments are described below in order to explain the present invention by referring to the figures.

The present disclosure r elates to a method and system for revising a click-through rate (CTR) that can revise a CTR used for calculating a rank of each advertisement, while integrating advertisements into a single product platform and displaying the integrated advertisements, and thereby can remove a premium according to a display rank of the advertisement.

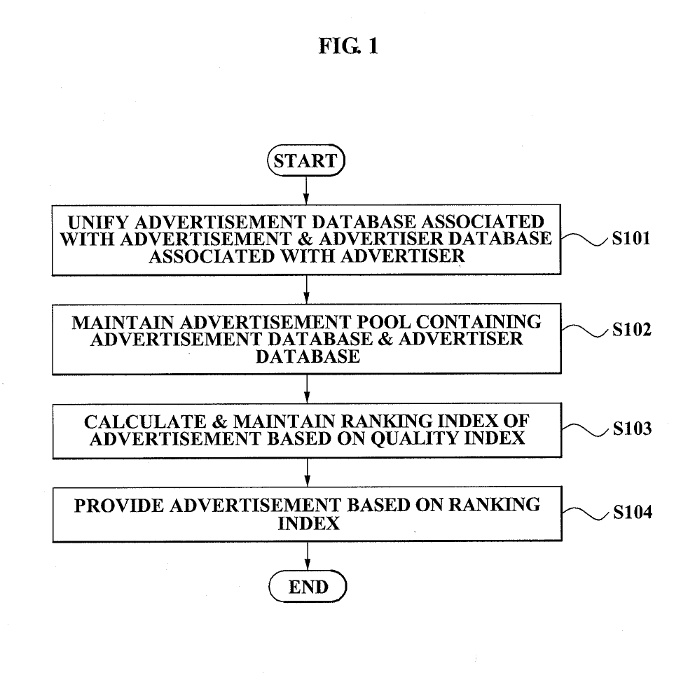

FIG. 1 is a flowchart illustrating a method of providing an advertisement according to an embodiment of the present invention. In operation S101, an advertisement providing system unifies an advertisement database associated with the advertisement and an advertiser database associated with an advertiser of the advertisement. Specifically, the advertisement providing system may unify a plurality of databases, separately managed for various types of advertisement regions, into the advertisement database and the advertiser database.

In operation S102, the advertisement providing system maintains an advertisement pool containing the advertisement database and the advertiser database. It will be apparent that the advertisement database and the advertiser database may be managed in interoperation with each other, or may be managed through a single advertisement database where advertisements are stored in correspondence to advertisers, respectively.

In operation S103, the advertisement providing system calculates and maintains a ranking index of the advertisement based on a quality index. The advertisement providing system may calculate the ranking index based on the quality index and a maximum cost per click of the advertisement. In this case, a different weight may be assigned to each of the maximum cost per click and the quality index. Specifically, the ranking index may be calculated based on multiplication between the maximum cost per click and the quality index that are assigned with a first weight and a second weight, respectively. Also, the maximum cost click may be entered by the advertiser of the advertisement as the maximum cost of the advertisement per click.

The quality index may be calculated based on a quality factor corresponding to a pre-evaluation element and a CTR corresponding to a post evaluation element with respect to a listing of the advertisement. In this case, the quality index may be a sum of the quality factor and the CTR that are assigned with a third weight and a fourth weight, respectively. The third weight and the fourth weight may be set so that a sum of the third weight and the fourth weight may equal a predetermined integer. For example, the third weight and the fourth weight may be set so that the sum of the third weight and the fourth weight may be “1”.

The quality factor may be measured based on pre-evaluated indexes by analyzing a user pattern such as title & description (T&D) scores associated with the advertisement, a site authority, and site scores. Herein, elements for measuring the quality factor are not limited to the T&D scores, the site authority, and the site scores. Any other pre-evaluation index obtained by analyzing user patterns may be used. Hereinafter, only three elements will be described for convenience of description. In this case, the quality factor may be calculated based on the T&D scores, the site authority, and the site scores that are assigned with a fifth weight, a sixth weight, and a seventh weight, respectively. The fifth through seventh weights may be determined based on a correlation coefficient with the CTR.

In operation S104, the advertisement providing system provides the advertisement based on the calculated ranking index. In this instance, the advertisement providing system may provide a predetermined number of advertisements in an order of higher ranking indexes. Specifically, the advertisement providing system may extract the predetermined number of advertisements from the advertisement database in an order of higher ranking indexes to display each of the extracted advertisements in a corresponding advertisement region.

In the case of advertisements with the same ranking index, a prior display advertisement may be selected based on at least one of the quality index, the CTR, an allowable budget, and a registered order. For example, when a plurality of advertisements has the same ranking index, an advertisement with the relatively high quality index may be preferentially displayed. When even the quality index is the same, an advertisement with relatively high CTR may be preferentially displayed.

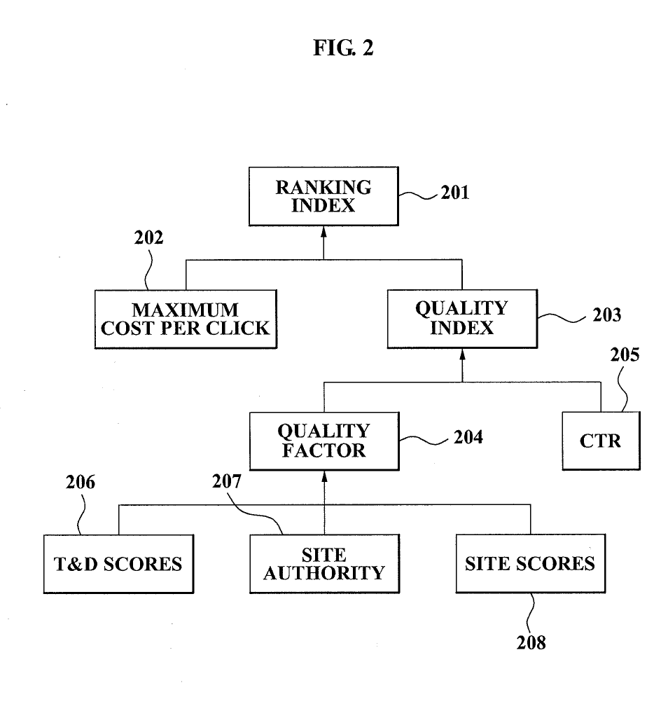

FIG. 2 illustrates an example of calculating a ranking index 201 according to an embodiment of the present invention. As shown in FIG. 2, the ranking index 201 may be calculated based on a maximum cost per click 202 and a quality index 203. The quality index 203 may be calculated based on a quality factor 204 and a CTR 205. The quality factor 204 may be obtained based on T&D scores 206, a site authority 207, and site scores 208.

Specifically, in order to calculate the ranking index 201, the advertisement providing system may assign a first weight and a second weight to the maximum cost per click 202 and the quality index 203, respectively, and multiply the maximum cost per click 202 with the assigned first weight by the quality index 203 with the assigned second weight. Specifically, the ranking index 201 may be expressed as,

Ranking index=(first weight×maximum cost per click)×(second weight×quality index). [Equation 1]

The maximum cost per click 202 may indicate the maximum cost that the advertiser is willing to pay when the advertisement registered for a keyword is clicked on. It is possible to limit the lowest amount of the maximum cost per click 202 by pre-determining a lowest bid amount that the advertiser may bid for each keyword.

The quality index 203 may be calculated by the combination of the quality factor 204 corresponding to the pre-evaluation element of the advertisement listing and the CTR 205 corresponding to the post-evaluation element thereof. The calculated quality index 203 may be used to evaluate the quality of the advertisement listing. The quality index 203 may be determined to a relative value affected by another listing registered for a corresponding keyword, instead of an absolute value being determined by only the corresponding listing.

More specifically, the quality index 203 may be calculated based on the multiplication between the quality factor 204 with the assigned third weight and the CTR 205 with the assigned fourth weight. The quality index 203 may be represented as,

Quality index=(third weight×quality factor)+(fourth weight×CTR). [Equation 2]

The third weight and the fourth weight may be set so that a sum of the third weight and the fourth weight may equal a predetermined integer. For example, the third weight and the fourth weight may be set so that the sum of the third weight and the fourth weight may be “1”. The advertisement providing system may adjust the ratio between the third weight and the fourth weight, thereby weighting either the pre-evaluation element or the post-evaluation element. Specifically, the advertisement providing system may provide the advertisement based on the initially set third weight and fourth weight and may adjust the ratio between the third weight and the fourth weight through correlation analysis on the quality index 203, the CTR 205, and sales of the advertisement.

Also, the quality index 203 may be revised so that the difference between a maximum value and a minimum value with respect to an advertisement listing displayed in association with a corresponding keyword may not exceed a predetermined value. Through this, the quality index 203 may be enabled to have a more objective value.

The quality factor 204 may be measured based on at least one of the T&D scores 206 associated with the advertisement, the site authority 207, and the site scores 208. Specifically, the advertisement providing system may measure the quality factor 204 using a desired element, as necessary. In the case of using all the elements, the T&D scores 206, the site authority 207, and the site scores 208, Equation 2 may be represented as,

Quality index=(third weight×((fifth weight×T&D scores)+(sixth weight×site authority)+(seventh weight×site scores)))+(fourth weight×CTR). [Equation 3]

The T&D scores 206 denotes a relevance value of T&D set by the advertiser of the advertisement. The T&D scores 206 may be measured based on a first relevance value and a second relevance value. The first relevance value may indicate the relevance between a keyword and the T&D, and the second relevance value may indicate the relevance between words included in the T&D. For example, the T&D scores 206 may be measured based on the sum of the first relevance value and the second relevance value.

The site authority 207 denotes a class system that is measured based on a number of user visits, a user satisfaction, and a relevance with respect to a site. In the case of an advertisement site, since the distribution is insufficient and leans to one side, the site authority 207 may be used to revise the quality index 203, particularly, the quality factor 204 corresponding to the pre-evaluation element.

The site scores 208 denotes a value obtained by measuring the relevance between the site and the keyword, while crawling the site. The site scores 208 may be used to adjust the seventh weight according to technology and depth of crawling. For example, it is possible to use the content match (CM) relevance for a site of an advertiser, or points determining a rank of a search algorithm of web searching. When using the points determining the rank of the search algorithm, it is possible to use the existing measured points as is.

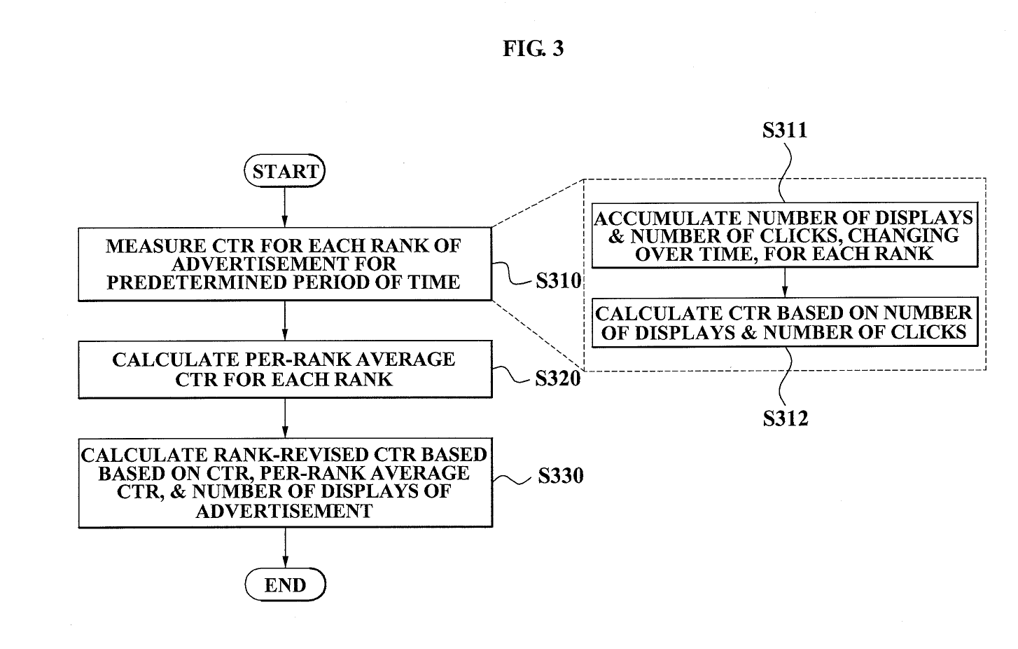

FIG. 3 is a flowchart illustrating a method of revising a CTR according to an embodiment of the present invention. In operation S310, a CTR revision system for revising the CTR measures a CTR for each rank of an advertisement for a predetermined period of time. In this instance, the CTR may be one described above with reference to FIGS. 1 and 2. The rank may be determined based on a ranking index that is based on a quality index and a maximum cost per click of the advertisement.

The maximum cost per click may be input by an advertiser of the advertisement as a maximum cost of the advertisement per click. The quality index may be calculated based on a quality factor corresponding to a pre-evaluation element and a CTR of a previous period corresponding to a post evaluation element with respect to a listing of the advertisement. Also, the quality factor may be measured based on at least one of T&D scores associated with the advertisement, a site authority, and site scores.

Specifically, the rank of the advertisement is determined based on the ranking index. The ranking index is affected by the CTR. Since the CTR includes a premium according to the rank, it is possible to remove the premium by revising the CTR through operations S320 and S330.

Also, the predetermined period of time may be set to be the same as a period of time for revising the CTR, or may be set to a desired period as necessary.

In operation S311, the CTR revising system accumulates a number of displays and a number of clicks, changing over time, for each rank. The CTR may indicate only a CTR that includes a number of displays greater than or equal to a number of reliable displays or listings. The number of reliable displays may be calculated based on a number of average daily references of a corresponding keyword and a number of average daily displays of the keyword. The reason of using only the CTR with the number of displays greater than or equal to the number of reliable displays is because, for example, a CTR of 50% in a case where a listing of an advertisement was displayed twice and clicked on once in a day cannot be regarded as same as a CTR of 50% in a case where listing of the advertisement was displayed 200 times and clicked on 100 times in a day.

As an example of determining the number of reliable displays, it is possible to use a scheme of setting a minimum value of a number of average daily displays to 50 times and assigning a predetermined weight to a number of average daily references measured based on ten days to thereby determine, as the number of reliable displays, a greater value between 50 times and the number of daily average references with the assigned weight. Here, the numerical values such as “50”, “10”, and the like are only an example for convenience of description and thus it will be apparent that modifications and changes can be made.

The determined number of reliable displays may indicate a minimum number of displays or listings corresponding to an available CTR of CTRs.

In operation S312, the CTR revising system calculates the CTR based on the number of displays and the number of clicks. Specifically, the CTR revising system may calculate the CTR based on the number of displays and the number of clicks that are accumulated in operation S311. More specifically, the CTR revising system may calculate, as the CTR, the ratio of the number of clicks to the number of displays, represented as the percentage. For example, when the number of displays is “100” and the number of clicks is “50”, the CTR may be calculated as “50/100×100=50%”.

In operation S320, the CTR revising system calculates the per-rank CTR for each rank. The per-rank average CTR or average CTRs-at-rank may include the average CTR of all the keywords existing in the same rank, for each rank. Specifically, the CTR revising system may calculate the average CTR with respect to all the keywords existing in the same rank and may calculate the per-rank average CTR corresponding to the average CTR for each rank including the advertisement.

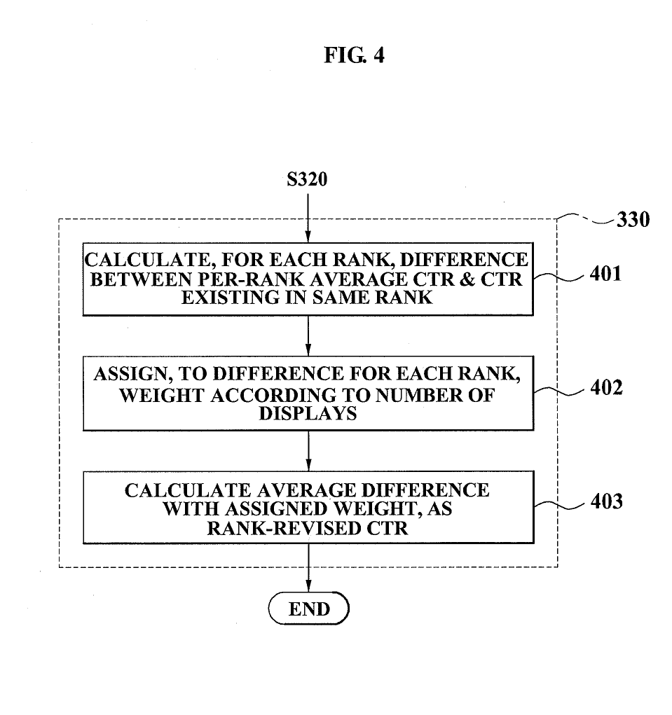

In operation S330, the CTR revising system calculates a rank-revised CTR based on the CTR, the per-rank average CTR, and a number of displays of the advertisement. The per-rank average CTR and the number of displays are used for revising the CTR. A method of calculating the rank-revised CTR corresponding to a revised value of the CTR based on the per-rank average CTR, the number of displays, and the CTR will be described in detail with reference to FIG. 4.

FIG. 4 is a flowchart illustrating a method of calculating a rank-revised CTR according to an embodiment of the present invention. As shown in FIG. 4, operation S401 through S403 will be included in operation S330 of FIG. 3 and be performed by a CTR revising system.

In operation S401, the CTR revising system calculates, for each rank, the difference between the CTR and the per-rank average CTR of all the keywords included in the same rank. Specifically, the CTR revising system calculates the difference by subtracting the per-rank average CTR from the CTR-at-rank or CTR existing in each rank.

In operation S402, the CTR revising system assigns, to the difference for each rank, a weight according to the number of displays. Specifically, the CTR revising system may calculate the weight for each rank according to the number of displays measured for each rank and assign the weight to the difference. The weight may be set to be greater as the number of displays increases.

In operation S403, the CTR revising system calculates the average difference with the assigned weight, as the rank-revised CTR or adjusted CTR. For example, the CTR revising system may calculate the average by calculating a sum of differences with the assigned weight with respect to all the ranks and by dividing the sum by a number of ranks. Through this, the average may be obtained. As described above, it is possible to calculate, as the rank-revised CTR, the average difference with the assigned weight according to the number of displays. Also, it is possible to use the rank-revised CTR as the revised CTR with respect to the CTR.

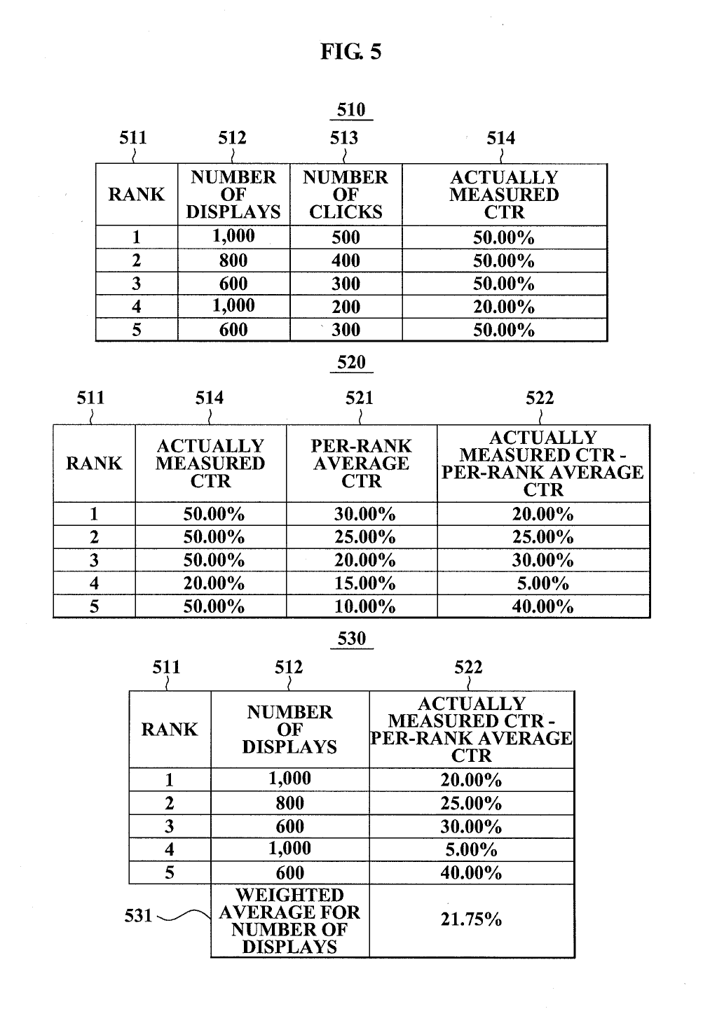

FIG. 5 illustrates an example of revising a CTR of a keyword advertisement according to an embodiment of the present invention. As described above, the CTRs may be measured based on a number of displays 512, and a number of clicks 513 of an advertisement for each of the ranks 511 that are assigned to the keyword advertisement in a predetermined period. More specifically, as shown in a table 510, an actually measured CTR 514 of a listing may be obtained as the CTR when using the rank 511, the number of displays 512, and the number of clicks 513. For example, the ratio of the number of displays 512 to the number of clicks 513 using a percentage may be obtained as the actually measured CTR 514.

In this instance, the actually measured CTR 514 may need to satisfy a number of reliable displays and may be a value in which an invalid click and an invalid display is removed. Specifically, when calculating a quality index reflecting the advertisement quality and the advertising effect, the number of reliable displays may be used as a fixed standard making it possible to rely on the actually measured CTR 514. The CTR may include a number of displays greater than or equal to a number of reliable displays, and the number of reliable displays may be calculated based on a number of average daily references of a corresponding keyword and a number of average daily displays of the keyword.

For example, a CTR of 50% in a case where a listing of an advertisement was displayed twice and clicked on once in a day cannot be regarded as same as a CTR of 50% in a case where the listing of the advertisement was displayed 200 times and clicked on 100 times in a day. Therefore, only with respect to an advertisement that has been displayed as many as a predetermined number of displays, i.e. the number of reliable displays, the actually measured CTR 514 of the advertisement may be admitted and be reflected for calculation of the quality index. As described above, the actually measured CTR 514 may be reflected in calculating the quality index as the CTR in which the ranking element is removed.

As shown in a table 520, an actually measured CTR-per-rank average CTR 522 may be obtained by subtracting a per-rank average CTR 521 from the actually measured CTR 514. Here, the per-rank average CTR 521 is the average CTR of all the keywords existing in a corresponding rank. When calculating a weighted average according to the number of displays 512, a weighted average for number of displays 531 may be obtained as shown in a table 530. The weighted average for number of displays 531 may be used as a rank-revised CTR.

More specifically, the rank-revised CTR may be obtained by assigning, to the difference between the actually measured CTR 514 corresponding to the CTR measured for each advertisement rank, and the per-rank average CTR 521 corresponding to the average CTR of all the keywords existing in each rank, a weight according to the number of displays accumulated for each rank, and by averaging the result. The obtained rank-revised CTR may be used as a revised CTR in which a ranking element, i.e. a premium according to the rank is removed in the actually measured CTR 514.

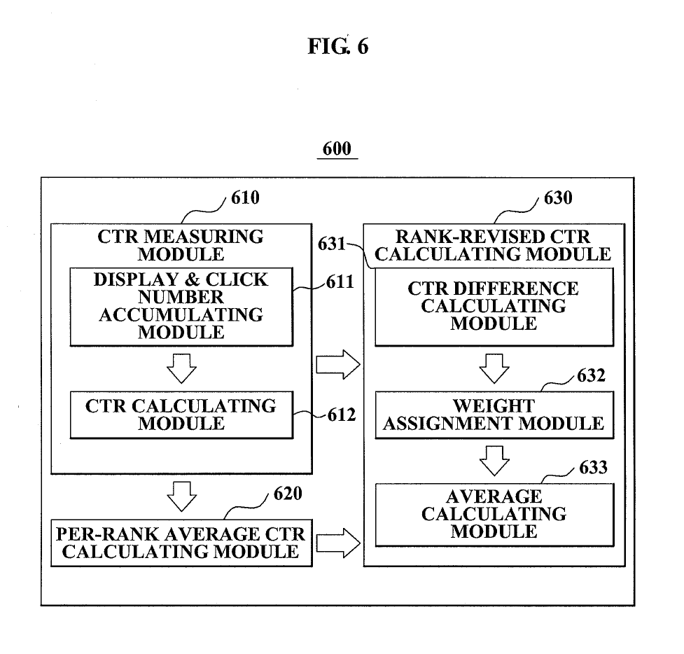

FIG. 6 is a block diagram illustrating an internal configuration of a system 600 for revising a CTR according to an embodiment of the present invention. As shown in FIG. 6, the CTR revising system 600 may include a CTR measuring module 610, a per-rank-average CTR calculating module 620, and a rank-revised CTR calculating module 630.

The CTR measuring module 610 measures a CTR for each rank of an advertisement for a predetermined period of time. In this instance, the rank may be determined based on a ranking index that is based on a quality index and a maximum cost per click of the advertisement. The maximum cost per click may be input by an advertiser of the advertisement as a maximum cost of the advertisement per click. The quality index may be calculated based on a quality factor corresponding to a pre-evaluation element and a CTR corresponding to a post evaluation element with respect to a listing of the advertisement. Also, the quality factor may be measured based on at least one of T&D scores associated with the advertisement, a site authority, and site scores. Specifically, the rank of the advertisement is determined based on the ranking index. The ranking index is affected by the CTR.

In this instance, as shown in FIG. 6, the CTR measuring module 610 may include a display-and-click number accumulating module 611 and a CTR calculating module 612 in order to measure the CTR.

The display-and-click number accumulating module 611 accumulates a number of displays and a number of clicks, changing over time, for each rank. The CTR may indicate only a CTR that includes a number of displays greater than or equal to a number of reliable displays. The number of reliable displays may be calculated based on a number of average daily references of a corresponding keyword and a number of average daily displays of the keyword. The reason of using only the CTR with the number of displays greater than or equal to the number of reliable displays is because, for example, a CTR of 50% in a case where a listing of an advertisement was displayed twice and clicked on once in a day cannot be regarded as same as a CTR of 50% in a case where the listing of the advertisement was displayed 200 times and clicked on 100 times in a day.

As an example of determining the number of reliable displays, it is possible to use a scheme of setting a minimum value of a number of average daily displays to 50 times and assigning a predetermined weight to a number of average daily references measured based on ten days to thereby determine, as the number of reliable displays, a greater value between 50 times and the number of daily average references with the assigned weight. Here, the numerical values such as “50”, “10”, and the like are only an example for convenience of description and thus it will be apparent that modifications and changes can be made. The determined number of reliable displays may indicate a minimum number of displays corresponding to an available CTR of CTRs.

The CTR calculating module 612 calculates the CTR based on the number of displays and the number of clicks. Specifically, the CTR calculating module 612 may calculate the CTR based on the number of displays and the number of clicks that are accumulated in the display-and-click number accumulating module 611. More specifically, the CTR calculating module 612 may calculate, as the CTR, the ratio of the number of clicks to the number of displays, represented as the percentage. For example, when the number of displays is “100” and the number of clicks is “50”, the CTR may be calculated as “50/100×100=50%”.

In this instance, since the CTR includes a premium according to the rank, it is possible to remove the premium by revising the CTR via the per-rank average CTR calculating module 620 and the rank-revised CTR calculating module 630.

The per-rank average CTR calculating module 620 calculates the per-rank CTR for each rank. The per-rank average CTR may include the average CTR of all the keywords existing in the same rank, for each rank. Specifically, the per-rank average CTR calculating module 620 may calculate the average CTR with respect to all the keywords existing in the same rank and may calculate the per-rank average CTR corresponding to the average CTR for each rank including the advertisement.

The rank-revised CTR calculating module 630 calculates a rank-revised CTR based on the CTR, the per-rank average CTR, and a number of displays of the advertisement. The per-rank average CTR and the number of displays are used for revising the CTR. In order to calculate the rank-revised CTR corresponding to a revised value of the CTR based on the per-rank average CTR, the number of displays, and the CTR, the rank-revised CTR calculating module 630 may include a CTR difference calculating module 631, a weight assignment module 632, and an average calculating module 633.

The CTR difference calculating module 631 calculates, for each rank, the difference between the per-rank average CTR and the CTR of all the keywords included in the same rank. Specifically, the CTR difference calculating module 631 calculates the difference by subtracting the per-rank average CTR from the CTR existing in each rank.

The weight assignment module 632 assigns, to the difference for each rank, a weight according to the number of displays. Specifically, the weight assignment module 632 may calculate the weight for each rank according to the number of displays measured for each rank and assign the weight to the difference. The weight may be set to be greater as the number of displays increases.

The average calculating module 633 calculates the average difference with the assigned weight, as the rank-revised CTR. For example, the average calculating module 633 may calculate the average by calculating a sum of differences with the assigned weight with respect to all the ranks and by dividing the sum by a number of ranks. Through this, the average may be obtained. As described above, it is possible to calculate, as the rank-revised CTR, the average difference with the assigned weight according to the number of displays. Also, it is possible to use the rank-revised CTR as the revised CTR with respect to the CTR.

As described above, when using a method and system for revising a CTR according to embodiments of the present invention, it is possible to calculate a ranking index based on a quality factor indicating the advertisement quality and a CTR indicating the advertising effect and to display the advertisement according to the ranking index, thereby reflecting the advertisement quality and advertising effect in the display rank of the advertisement. Also, it is possible to revise the CTR based on a per-rank average CTR corresponding to the average CTR of all the keywords existing in each rank and a weight according to a number of displays, thereby removing a premium according to the display rank of the advertisement.

The CTR revising method according to embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. The media may also be a transmission medium such as optical or metallic lines, wave guides, and the like, including a carrier wave transmitting signals specifying the program instructions, data structures, and the like. Examples of program instructions include both machine code, such as produced by a compiler, and files containing higher level code that may be executed by the computer using an interpreter. The described hardware devices may be configured to act as one or more software modules in order to perform the operations of embodiments of the present invention.

According to embodiments of the present invention, there may be provided a method and system for revising a CTR that can calculate a ranking index based on a quality factor indicating the quality of an advertisement and CTR indicating the advertising effect and display the advertisement based on the ranking index, and thereby can reflect the advertisement quality and the advertising effect in a display rank of the advertisement.

Also, according to embodiments of the present invention, there may be provided a method and system for revising a CTR that can revise a CTR based on a per-rank average CTR corresponding to the average CTR of all the keywords existing in each rank and a weight according to a number of displays and thereby can remove a premium according to a display rank of an advertisement.

Although various embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A method of running a keyword advertisement service, the method comprising:
providing a plurality of CTRs-at-rank of a first keyword advertisement using a keyword, wherein each CTR-at-rank of the first keyword advertisement represents a click-through rate for the first keyword advertisement during a predetermined period when the first keyword advertisement is at each of the plurality of ranks among a group of keyword advertisements using the same keyword;
providing a plurality of average CTRs-at-rank of a plurality of keyword advertisements, wherein each average CTR-at-rank represents an average value of collective click-through rates of the plurality of keyword advertisements during a preselected period when each of the plurality of keyword advertisements is at one of the plurality of ranks; and
computing an adjusted CTR of the first keyword advertisement using, at least in part, the plurality of CTRs-at-rank of the first keyword advertisement and the plurality of average CTRs-at-rank of the plurality of keyword advertisements.

2. The method of claim 1, wherein computing further uses a count of listings of the first keyword advertisement contained in keyword search results formulated in reply to keyword searches using the keyword during the predetermined period.

3. The method of claim 1, wherein two or more of the group of keyword advertisements are at the same rank at different times during the predetermined period.

4. The method of claim 1, wherein providing the plurality of CTRs-at-rank comprising:
providing a count of listings of the first keyword advertisement contained in keyword search results formulated in reply to keyword searches using the keyword when the first keyword advertisement is at a first one of the plurality of ranks during the predetermined period;
providing a count of clicks of the first keyword advertisement when the first keyword advertisement is at the first rank during the predetermined period; and
computing a first CTR-at-rank for the first rank using the count of listings and the count of clicks.

5. The method of claim 1, wherein a first CTR-at rank of the first keyword advertisement is a ratio of a count of click-throughs to a count of listings of the first keyword advertisement as the first rank on keyword search results during the predetermined period, wherein the first CTR-at-rank is not used in computing the adjusted CTR of the first keyword advertisement when the count of listings as the first rank is smaller than or equal to a predetermined number.

6. The method of claim 1, wherein a first CTR-at rank of the first keyword advertisement is a ratio of a count of click-throughs to a count of listings of the first keyword advertisement as the first rank on results of keyword searches, wherein the first CTR-at-rank is not used in computing the adjusted CTR of the first keyword advertisement when the number of the keyword searches during the predetermined period is smaller than or equal to a predetermined number.

7. The method of claim 1, wherein the collective click-through rates at a particular rank are a sum of a CTR-at-rank of each keyword advertisement of the all or part of the plurality of keyword advertisements when said each keyword advertisement is at the particular rank.

8. The method of claim 1, wherein computing comprises subtracting a first one of the plurality of average CTRs-at-rank for a first one of the plurality of ranks from a first one of the plurality of CTRs-at-rank for the first rank so as to generate a first adjusted CTR-at-rank of the first keyword advertisement for the first rank.

9. The method of claim 8, wherein computing further comprises repeating subtracting an average CTR-at-rank of the plurality of keyword advertisements from a CTR-at-rank of the first keyword advertisement for the remainder of the plurality of ranks so as to generate an adjusted CTR-at-rank of the first keyword advertisement for each of the remainder of the plurality of ranks.

10. The method of claim 9, wherein computing further comprises summing the first adjusted CTR-at-rank and the adjusted CTRs-at-rank so as to generate said adjusted CTR of the keyword advertisement.

11. The method of claim 1, further comprising ranking the first keyword advertisement among the group of keyword advertisements using the adjusted click-through rate (CTR) of the first keyword advertisement.

12. The method of claim 11, wherein ranking comprising comparing the adjusted CTR of the first keyword advertisement against CTRs or adjusted CTRs of the others of the group of keyword advertisements.

13. The method of claim 12, further comprising:
receiving, from a user's terminal, a request for a keyword search using the keyword;
conducting a keyword search using the keyword; and
transmitting, to the user's terminal, a result of the keyword search along with all or part of the group of keyword advertisements such that the keyword advertisements are displayed in an order according to rankings thereof.

14. A method of running a keyword advertisement service, the method comprising:
providing a plurality of CTRs-at-rank of a first keyword advertisement using a keyword, wherein each CTR-at-rank of the first keyword advertisement represents a click-through rate for the first keyword advertisement during a predetermined period when the first keyword advertisement is at each of the plurality of ranks among a group of keyword advertisements using the same keyword;
providing a plurality of adjustment factors for adjusting the CTRs-at-rank, each adjustment factor is associated with one of the plurality of ranks; and
computing an adjusted CTR of the first keyword advertisement, at least in part, using the plurality of CTRs-at-rank and the plurality of adjustment factors.

15. The method of claim 14, wherein computing the adjusted CTR of the first keyword advertisement comprises computing a plurality of adjusted CTRs-at-rank of the first keyword advertisement.

16. The method of claim 15, wherein a first one of the plurality of adjusted CTRs-at-rank for a first one of the plurality of ranks is computed with a formula using a first one of the plurality of CTRs-at-rank representing a CTR when the first keyword advertisement is at the first rank and a first adjustment factor.

17. The method of claim 16, wherein at least one of the formula and the adjustment factor is designed such that the first adjusted CTR-at-rank becomes smaller than the first CTR-at-rank when the first rank is the highest rank among the plurality of ranks.

18. The method of claim 17, wherein the formula comprises a multiplication of the first adjustment factor by the first CTR-at-rank.

19. The method of claim 16, wherein the formula comprises a subtraction of the first adjustment factor from the first CTR-at-rank.

20. The method of claim 19, wherein the first adjustment factor is an average CTR-at-rank of a plurality of keyword advertisements and represents an average value of collective click-through rates of the plurality of keyword advertisements during a preselected period when each of the group of keyword advertisements is at the first rank.

21. The method of claim 20, wherein the collective click-through rates at the first rank are the sum of CTRs-at-rank of each of the plurality of keyword advertisements when said each keyword advertisement is at the particular rank.

22. The method of claim 15, wherein computing the adjusted CTR of the first keyword advertisement further comprises summing the plurality of adjusted CTRs-at-rank of the first keyword advertisement.

23. The method of claim 15, wherein computing the adjusted CTR of the first keyword advertisement further comprises summing only part of the plurality of adjusted CTRs-at-rank of the first keyword advertisement.

24. The method of claim 14, further comprising ranking the first keyword advertisement among the group of keyword advertisements using the adjusted CTR of the first keyword advertisement.

25. The method of claim 24, wherein ranking comprising comparing the adjusted CTR of the first keyword advertisement against CTRs or adjusted CTRs of the others of the group of keyword advertisements.

26. The method of claim 14, wherein the plurality of keyword advertisements uses the keyword.

27. The method of claim 14, wherein the plurality of keyword advertisements comprises entire keyword advertisements used in a keyword advertisement service or a portion of the entire keyword advertisements.

28. A method of running a keyword advertisement service, the method comprising:
providing a CTR-at-rank of a first keyword advertisement using a keyword, wherein the CTR-at-rank of the first keyword advertisement represents a click-through rate for the first keyword advertisement during a predetermined period when the first keyword advertisement is at a first one of the plurality of ranks among a group of keyword advertisements using the same keyword;
providing an average CTR-at-rank of a plurality of keyword advertisements, wherein the average CTR-at-rank represents an average value of collective click-through rates of the plurality of keyword advertisements during a preselected period when the plurality of keyword advertisements is at the first rank; and
computing an adjusted CTR of the first keyword advertisement using the CTR-at-rank of the first keyword advertisement and the average CTR-at-rank of the plurality of keyword advertisements.
